(19) United States
(12) Patent Application Publication
(10) Pub. No.: US 2026/0185730 A1
(43) Pub. Date: Jul. 2, 2026

(54) TEMPERATURE AND AIRFLOW PREDICTING SYSTEM AND METHOD THEREOF

(71) Applicant: INDUSTRIAL TECHNOLOGY RESEARCH INSTITUTE, Hsinchu (TW)

(72) Inventors: Jui-Jen CHIEH, Zhudong Township (TW); Hung-Tsai WU, Zhubei City (TW); Chia-Wei HSU, New Taipei City (TW); Yi-Lun CHEN, Chiayi City (TW)

(73) Assignee: INDUSTRIAL TECHNOLOGY RESEARCH INSTITUTE, Hsinchu (TW)

(21) Appl. No.: 19/200,965

(22) Filed: May 7, 2025

(30) Foreign Application Priority Data
Jan. 2, 2025 (TW) 114100113

(51) Int. Cl. F24F 11/64; F24F 3/167; F24F 11/49; F24F 11/84; F24F 110/10; F24F 110/30; F24F 140/50; G01K 13/024; G01P 5/00

(52) U.S. Cl. CPC F24F 11/64; F24F 11/49; F24F 11/84; G01K 13/024; G01P 5/001; F24F 3/167; F24F 2110/10; F24F 2110/30; F24F 2140/50

(57) ABSTRACT

A temperature and airflow predicting system, comprises the following elements. A sensing device senses a temperature and an airflow of an operating field to generate a current-state temperature distribution data and a current-state airflow distribution data. A simulating device performs a computational fluid dynamics simulation for the temperature and airflow based on a boundary condition data to generate a simulated temperature distribution data and a simulated airflow distribution data. A database establishes a current-state data set and a simulated data set based on the current-state temperature distribution data, the current-state airflow distribution data, the simulated temperature distribution data and the simulated airflow distribution data. A predicting device performs a model operation based on the current-state data set, the simulated data set and a predicting load model, so as to predict the temperature and the airflow and thereby generating a predicted temperature distribution data and a predicted airflow distribution data.

### TECHNICAL FIELD

This application claims the benefit of Taiwan application Serial No. 114100113, filed Jan. 2, 2025, the disclosure of which is incorporated by reference herein in its entirety.

The present disclosure relates to a predicting mechanism, and particularly relates to a temperature and airflow predicting system and a method thereof.

### BACKGROUND

In a production line of a semiconductor manufacturing process, the operating environment of a clean room (or a dust-free room) needs to be strictly controlled to facilitate the manufacture of precise semiconductor components. In particular, the temperature and humidity of the clean room must be controlled within a low error range. Therefore, clean rooms are equipped with air conditioning systems to control the temperature and humidity. The air conditioning system operates continuously for all day long to maintain low error temperature and humidity.

The temperature control mechanism of certain traditional air conditioning system utilizes computational fluid dynamics (CFD) to simulate the airflow distribution data and the temperature distribution data in the clean room. However, in some cases, the CFD has high computational complexity and requires huge computing time and cost. In addition, the air conditioning system operates for all day long and requires huge power costs. Therefore, some traditional air conditioning systems in clean rooms may often cause huge carbon emissions and hence increase social costs.

In response to the above issues, it needs to provide an improved temperature and airflow predicting mechanism that can reduce computational complexity and computational time and have good predicting accuracy.

### SUMMARY

According to one embodiment of the present disclosure, a temperature and airflow predicting system configured to be applied to an operating field is provided. The temperature and airflow predicting system comprises the following elements. A sensing device, for sensing a plurality of temperature readings of the operating field to obtain a current-state temperature distribution data, and sensing a plurality of airflow readings of the operating field to obtain a current-state airflow distribution data. A simulating device, for performing a simulation with computational fluid dynamics (CFD) on temperature and airflow according to a boundary condition data of the operating field, so as to generate a simulated temperature distribution data and a simulated airflow distribution data. A database, for storing the current-state temperature distribution data and the current-state airflow distribution data to establish a current-state data set, and storing the simulated temperature distribution data and the simulated airflow distribution data to establish a simulated data set. A predicting device, for performing a model operation based on the current-state data set, the simulated data set and a predicting load model to predict the temperature and the airflow, so as to generate a predicted temperature distribution data and a predicted airflow distribution data of the operating field.

According to another embodiment of the present disclosure, a temperature and airflow predicting method configured to be applied to an operating field is provided. The temperature and airflow predicting method comprises the following steps. A plurality of temperature readings of the operating field is sensed to obtain a current-state temperature distribution data, and a plurality of airflow readings of the operating field is sensed to obtain a current-state airflow distribution data, by a sensing device. A simulation with computational fluid dynamics (CFD) is performed on temperature and airflow according to a boundary condition data of the operating field, so as to generate a simulated temperature distribution data and a simulated airflow distribution data, by a simulating device. The current-state temperature distribution data and the current-state airflow distribution data is stored to establish a current-state data set, and the simulated temperature distribution data and the simulated airflow distribution data are stored to establish a simulated data set, by a database. A model operation is performed based on the current-state data set, the simulated data set and a predicting load model by a predicting device to predict the temperature and the airflow, so as to generate a predicted temperature distribution data and a predicted airflow distribution data of the operating field.

### BRIEF DESCRIPTION OF THE DRAWINGS

FIG. 1 is a block diagram of a temperature and airflow predicting system according to an embodiment of the present disclosure.

FIGS. 2A and 2B are schematic diagrams of an operating field according to an embodiment of the present disclosure.

FIG. 3 is a schematic diagram of the air conditioning system disposed in the operating field.

FIG. 4A is a schematic diagram of a predicting load model of a predicting device.

FIG. 4B is a block diagram of the predicting device.

FIG. 5 is a schematic diagram showing the control device controls the air conditioning system.

FIG. 6 is a flow diagram of a temperature and airflow predicting method according to an embodiment of the present disclosure.

FIGS. 7A and 7B are schematic diagrams of the predicted temperature and test data of the operating field.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

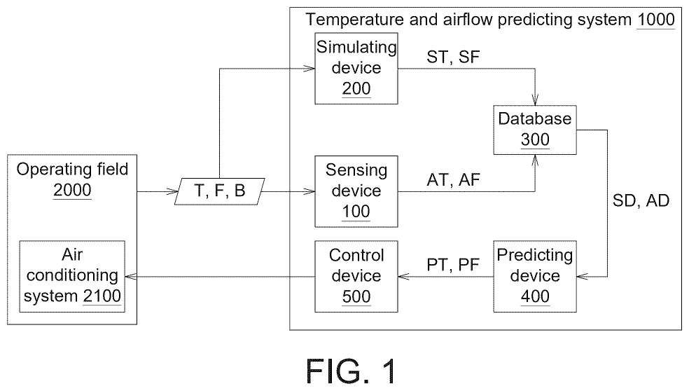

FIG. 1 is a block diagram of a temperature and airflow predicting system 1000 according to an embodiment of the present disclosure. The temperature and airflow predicting system 1000 is used to control the temperature of an operating field 2000, which may be, e.g., a clean room in a semiconductor production line. In one example, the temperature and airflow predicting system 1000 is (but not limited to) a processor in the form of a hardware circuit, such as a digital signal processor (DSP), a central processing unit (CPU), and a micro control unit (MCU). As shown in FIG. 1, the temperature and airflow predicting system 1000 comprises a sensing device 100, a simulating device 200, a database 300, a predicting device 400 and a control device 500. The sensing device 100, the simulating device 200, the predicting device 400 and the control device 500 are all hardware circuitry units inside the temperature and airflow predicting system 1000. The database 300 is a hardware storage device inside the temperature and airflow predicting system 1000, or the database 300 is a remote storage device or remote server outside the temperature and airflow predicting system 1000.

In another example, the temperature and airflow predicting system 1000 is a software program module, and the functions of the temperature and airflow predicting system 1000 are implemented by software codes inside a central processing unit or a digital signal processor. The sensing device 100, the simulating device 200, the predicting device 400 and the control device 500 in the temperature and airflow predicting system 1000 are all software modules, and their respective functions are realized by software codes (the software codes comprise a plurality of instructions). The above-mentioned software codes can be stored in a non-transitory computer-readable storage medium. The non-transitory computer-readable storage medium is, e.g., various forms of non-transitory (non-volatile) memories, hard disk, USB flash drive and other storage devices. The non-transitory computer-readable storage medium may be electrically connected to the CPU or the DSP, or may be disposed in the CPU or the DSP. The CPU or the DSP reads the software code from the non-transitory computer-readable storage medium and executes the instructions of the software codes to implement the functions of the sensing device 100, the simulating device 200, the predicting device 400 and the control device 500.

More specifically, the sensing device 100 is used to sense the temperature T and airflow F of the operating field 2000 during actual operation. For example, the operating field 2000 comprises a plurality of operating machines, and these operating machines may affect the temperature T and airflow F of the operating field 2000 during actual operation. The sensing device 100 may be disposed inside the operating field 2000 to sense the temperature T and the airflow F. Furthermore, the sensing device 100 generates a current-state temperature distribution data AT according to the sensed temperature T, and generates a current-state airflow distribution data AF according to the sensed airflow F.

The operating field 2000 has boundary condition data B related to temperature T and airflow F. The simulating device 200 analyzes the boundary condition data B and performs a simulation with computational fluid dynamics (CFD) on the temperature T and airflow F based on the boundary condition data B, so as to generate a simulated temperature distribution data ST and a simulated airflow distribution data SF.

The sensing device 100 transmits the current-state temperature distribution data AT and the current-state airflow distribution data AF to the database 300 for storage. Similarly, the simulating device 200 transmits the simulated temperature distribution data ST and the simulated airflow distribution data SF to the database 300 for storage. The database 300 establishes the current-state temperature distribution data AT and the current-state airflow distribution data AF as a current-state data set AD, and establishes the simulated temperature distribution data ST and the simulated airflow distribution data SF as a simulated data set SD.

The predicting device 400 obtains the current-state data set AD and the simulated data set SD from the database 300. Furthermore, based on the current-state data set AD and the simulated data set SD, the predicting device 400 predicts the temperature T and the airflow F of the operating field 2000, so as to obtain a predicted temperature distribution data PT and a predicted airflow distribution data PF.

The control device 500 obtains the predicted temperature distribution data PT and the predicted airflow distribution data PF from the predicting device 400. Furthermore, the control device 500 generates a control signal C1 according to the predicted temperature distribution data PT and the predicted airflow distribution data PF. Then, the control device 500 controls the air conditioning system 2100 of the operating field 2000 according to the control signal C1, so as to command the air conditioning system 2100 to adjust the temperature T of the operating field 2000.

According to the above-mentioned operations, the data flows of the sensing device 100, the simulating device 200, the database 300, the predicting device 400 and the control device 500 of the temperature and airflow predicting system 1000 of the present disclosure may form a feed-forward (FF) loop. The temperature and airflow predicting system 1000 controls the air conditioning system 2100 of the operating field 2000 through the FF loop to adjust the temperature T of the operating field 2000.

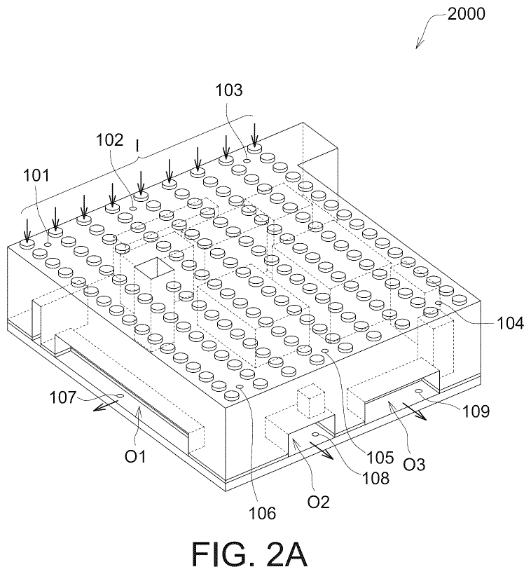

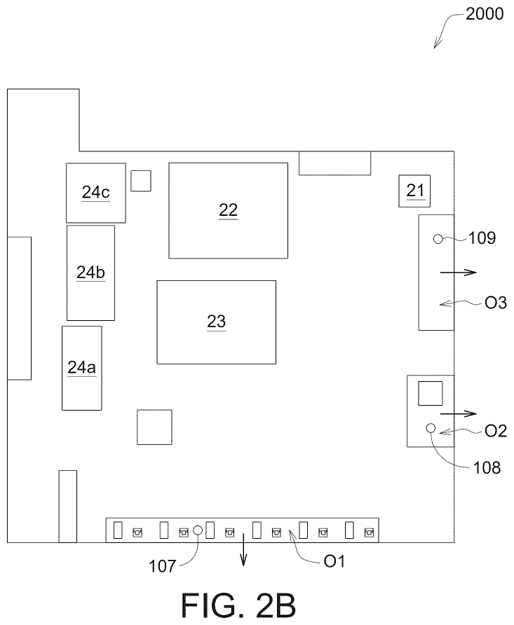

FIGS. 2A and 2B are schematic diagrams of an operating field 2000 according to an embodiment of the present disclosure. Please refer to FIGS. 2A and 2B, the operating field 2000 is, for example, a clean room of a semiconductor production line. The operating field 2000 is provided with a plurality of operating machines including a wafer bonding machine 21, an inductively coupled plasma etching machine 22, a plasma assisted chemical vapor deposition machine 23, and electron gun evaporation machines 24a, 24b and 24c. In addition, the operating field 2000 has an air inlet I and air outlets O1, O2 and O3. The air inlet I is disposed on the top ceiling of the operating field 2000. The air inlet I comprises, e.g., a plurality of circular holes in an array. The air outlets O1, O2 and O3 are respectively disposed at the bottom of the side walls of the operating field 2000. The air outlets O1, O2 and O3 are, e.g., rectangular channels.

The sensing device 100 is disposed according to the positions of the air inlet I and/or the air outlets O1, O2 and O3 of the operating field 2000. For example, the sensing device 100 comprises a plurality of sensing units 101-109. The sensing units 101-106 are disposed near some of the circular holes of the air inlet I on the top ceiling of the operating field 2000. The sensing units 101-106 are used to sense the temperature T and airflow F near the air inlet I when the operating machines are actually operating. On the other hand, the sensing units 107-109 are disposed corresponding to the air outlets O1, O2 and O3 at the bottom of the side walls of the operating field 2000. The sensing units 107-109 are used to sense the temperature T and airflow F near the air outlets O1, O2 and O3 when the operating machines are actually operating.

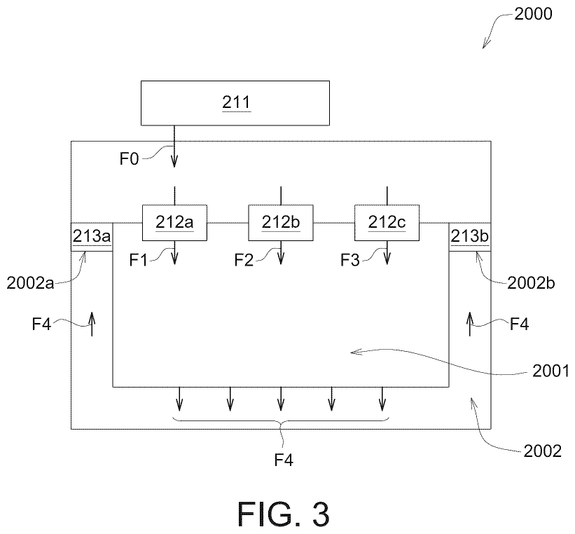

FIG. 3 is a schematic diagram of the air conditioning system 2100 disposed in the operating field 2000. As shown in FIG. 3, the air conditioning system 2100 comprises a make-up air unit (MAU) 211, fan filter units (FFU) 212a-212c, and dry cooling coils (DCC) 213a and 213b. The fan filter units 212a-212c are also referred to as “FFU fans”.

The make-up air unit 211 receives external air of the operating field 2000 and converts the external air into a cooling airflow F0 to be provided to the operating field 2000. Furthermore, each of the fan filter units 212a-212c converts the cooling airflow F0 provided by the make-up air unit 211 into corresponding cooling airflows F1-F3, and provide the cooling airflows F1-F3 to the internal space 2001 of the operating field 2000. The provided cooling airflow F1-F3 into the internal space 2001 may be referred to as “inlet air”.

Furthermore, the dry cooling coils 213a and 213b are disposed at the starting end 2002a and the terminating end 2002b of the return air channel 2002. Parts of the airflow in the internal space 2001 may enter the return air channel 2002, so as to form a return airflow F4 and circulate in the return air channel 2002. Parts of the airflow from the internal space 2001 and directed into the return air channel 2002 may be referred to as “outlet air”, and the return airflow F4 flowing through the return air channel 2002 may be referred to as “return air”. The dry cooling coil 213a can perform a cooling processing on the return airflow F4.

The sensing device 100 senses and performs statistical calculations on the temperature T and airflow F of the operating field 2000 during actual operation, so as to obtain statistical distribution data of the temperature T and airflow F during actual operation (i.e., current-state temperature distribution data AT and current-state airflow distribution data AF). In one example, the sensing device 100 is, e.g., an “α-site field” sensor, and the sensing device 100 can be serially connected to a Supervisory Control And Data Acquisition (SCADA) system. The data collecting and monitoring system can monitor several information of the operating field 2000 and the air conditioning system 2100, including: the load and power consumption of the ice water host, the temperature, humidity and pressure difference of the outlet air and return air of the air conditioning box, the rotational speed of the fan filter units, the temperature, humidity and pressure difference of the internal space 2001 of the operating field 2000, etc.

The temperature T and airflow F of the operating field 2000 have several boundary conditions, such as, the air inlet temperature, the air inlet speed, the return air temperature of the operating field 2000, the temperature and space information of the internal space 2001, the load (power consumption) of the operating machines, the flow rate of ice water of the ice water host, etc. In other words, the boundary conditions may comprise the information monitored by the aforementioned data collection and monitoring system. These boundary conditions may form the boundary condition data B.

The simulating device 200 receives boundary condition data B. Furthermore, the simulating device 200 performs CFD simulation and statistical calculations based on the temperature T, airflow F and boundary condition data B of the operating field 2000, so as to simulate the statistical distribution data of the temperature T and the airflow F (i.e., the simulated temperature distribution data ST and simulated airflow distribution data SF). The simulated temperature distribution data ST and simulated airflow distribution data SF generated by the simulating device 200 and the current-state temperature distribution data AT and current-state airflow distribution data AF generated by the sensing device 100 are stored in the database 300; and the database 300 establishes the above-mentioned statistical distribution data as a current-state data set AD and a simulated data set SD. Then, the predicting device 400 performs model operations based on the current-state data set AD and the simulated data set SD of the database 300, so as to predict the temperature T and airflow F in the future, of the operating field 2000. And thus, a predicted temperature distribution data PT and a predicted airflow distribution data PF are generated. The model operations of the predicting device 400 are described below.

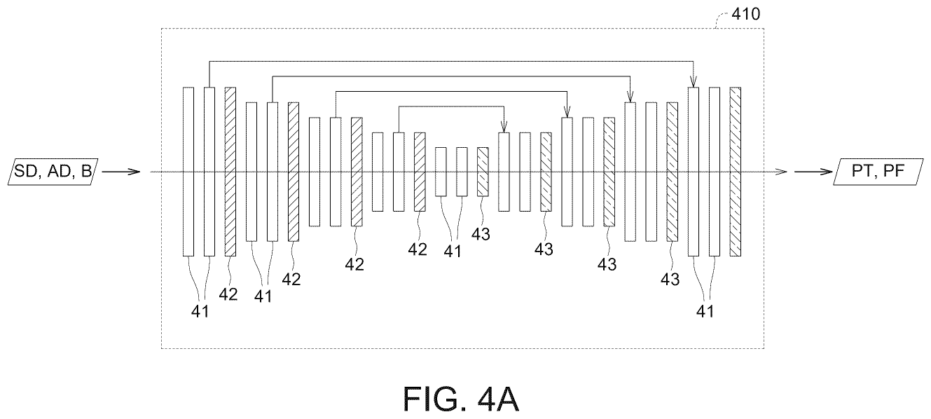

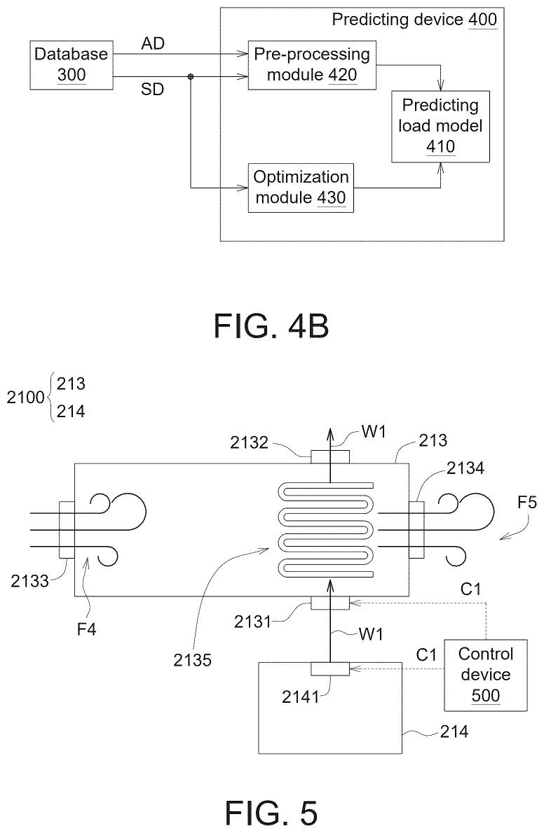

FIG. 4A is a schematic diagram of a predicting load model 410 of a predicting device 400. As shown in FIG. 4A, the predicting device 400 performs model operations based on the predicting load model 410 to predict the future temperature T and airflow F of the operating field 2000. The predicting load model 410 is, for example, a convolutional neural network (CNN) model, which has a structure similar to that of a U-Net model, including an input layer, a convolution layer, a pooling layer, an up-sampling layer, and an output layer. The predicting load model 410 can perform a convolution three-dimensional (Conv-3d) operation, including: a convolution operation 41, a maximum pooling (Max-pool) operation 42 and a transpose convolution (Transpose-Conv) operation 43.

The predicting load model 410 predicts the future temperature T and airflow F during an actual deployment phase. Before the actual deployment phase, the predicting load model 410 has a training phase and a testing phase. The predicting device 400 uses the current-state data set AD provided by the database 300 as a testing data set to train and test (i.e., verify) the predicting load model 410.

Furthermore, after the training phase and the testing phase of the predicted load model 410, the predicted load model 410 may further have a fine-tuning phase. The predicting device 400 may re-train the predicted load model 410 based on the simulated data set SD provided by the database 300, thereby fine-tuning the parameters of the predicted load model 410, which can calibrate and optimize the predicted load model 410.

Furthermore, before the training phase, the testing phase, and the fine-tuning phase of the predicting load model 410, the predicting device 400 may perform a pre-processing (including standardization processing and division processing) on the current-state data set AD and the simulated data set SD provided by the database 300, thereby standardizing and dividing the current-state data set AD and the simulated data set SD. The pre-processed current-state data set AD is more suitable for training and testing the predicting load model 410.

Please also refer to FIG. 4B, which is a block diagram of the predicting device 400. In one example, the predicting device 400 may further comprise a pre-processing module 420 and an optimization module 430.

The pre-processing module 420 receives the current-state data set AD and the simulated data set SD provided by the database 300. Before the training phase, the testing phase and the fine-tuning phase of the predicting load model 410, the pre-processing module 420 performs standardization processing and division processing on the current-state data set AD and the simulated data set SD, so as to make the current-state data set AD and the simulated data set SD more suitable for training and testing the predicting load model 410.

The optimization module 430 receives the simulated data set SD provided by the database 300. In the fine-tuning stage of the predicting load model 410, the optimization module 430 fine-tunes, calibrates, and optimizes the predicting load model 410 according to the simulated data set SD.

Please refer to FIG. 1 again, the predicted temperature distribution data PT and the predicted airflow distribution data PF generated by the predicting device 400 (generated through the model operations of the predicting load model 410) are provided to the control device 500. The control device 500 estimates the future temperature T and airflow F of the operating field 2000 according to the predicted temperature distribution data PT and the predicted airflow distribution data PF, and generates a corresponding control signal C1. Furthermore, the control device 500 feeds forward the control signal C1 to the air conditioning system 2100 of the operating field 2000, so as to adjust the temperature T of the operating field 2000 accordingly.

FIG. 5 is a schematic diagram showing the control device 500 controls the air conditioning system 2100. In the example of FIG. 5, the control device 500 further controls the dry cooling coil 213 and the ice water host 214 inside the air conditioning system 2100, so as to adjust the temperature T of the operating field 2000 accordingly.

The dry cooling coil 213 has a water inlet valve 2131, a water outlet valve 2132, an air inlet 2133 and an air outlet 2134, and is provided with a cooling coil 2135. The return airflow F4 flows into the inner cavity of the dry cooling coil 213 through the air inlet 2133, and flows through the cooling coil 2135. The cooling coil 2135 cools the return airflow F4, and which then forms the outlet airflow F5. The outlet airflow F5 flows out from the dry cooling coil 213 through the outlet 2134.

On the other hand, the ice water host 214 has a water outlet valve 2141. The ice water W1 provided by the ice water host 214 flows out from the ice water host 214 through the water outlet valve 2141, flows into the inner cavity of the dry cooling coil 213 through the water inlet valve 2131, and enters the cooling coil 2135. The cooling effect of the cooling coil 2135 on the return airflow F4 depends on the temperature or flow rate of the ice water W1.

In this embodiment, the cooling effect of the cooling coil 2135 is adjusted by controlling the flow rate of the ice water W1. The control device 500 controls the water outlet valve 2141 of the ice water host 214 and the water inlet valve 2131 of the dry cooling coil 213, through the control signal C1. The control signal C1 can control the degree for opening of the water outlet valve 2141 and the water inlet valve 2131, thereby controlling the flow rate of the ice water W1.

Based on the predicted temperature distribution data PT provided by the predicting device 400, the control device 500 can obtain the predicted temperature of the return airflow F4. When the predicted temperature of the return airflow F4 is higher, the control signal C1 of the control device 500 controls the water outlet valve 2141 and the water inlet valve 2131 to have a greater degree for opening, resulting in a larger flow rate of ice water W1, so that the cooling coil 2135 has a better cooling effect on the return airflow F4. On the contrary, when the predicted temperature of the return airflow F4 is lower, the water outlet valve 2141 and the water inlet valve 2131 are controlled to have a smaller degree for opening, so as to reduce the flow rate of the ice water W1. In one example, the degree for opening of the water outlet valve 2141 and the water inlet valve 2131 are positively correlated with the predicted temperature of the return airflow F4.

In another example, the control signal C1 of the control device 500 can also control the ice water host 214 to adjust the temperature of the ice water W1 (not shown in FIG. 5) , thereby adjusting the cooling effect of the cooling coil 2135 on the return airflow F4.

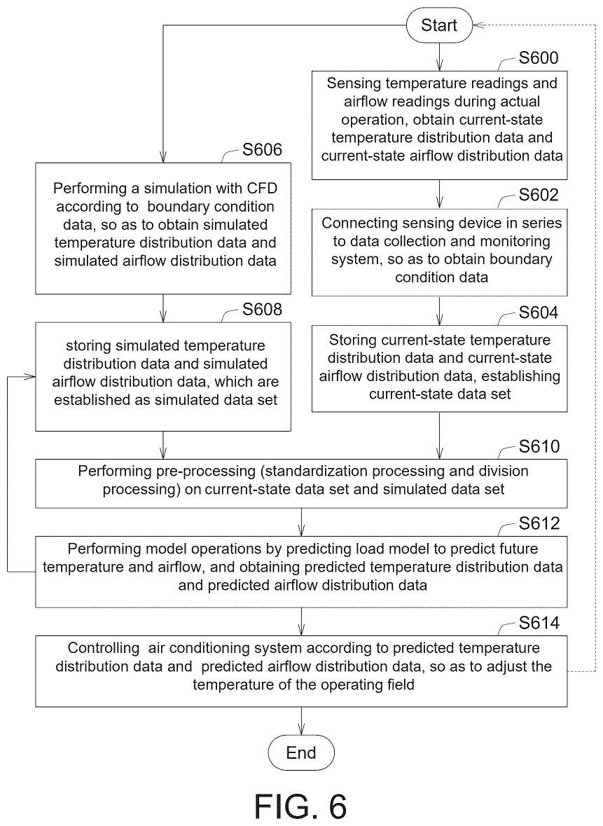

FIG. 6 is a flow diagram of a temperature and airflow predicting method according to an embodiment of the present disclosure. The temperature and airflow predicting method of this embodiment can be implemented by the temperature and airflow predicting system of FIG. 1. As shown in FIG. 6, first, step S600 is executed: the temperature T and the airflow F of the operating field 2000 during actual operation are sensed by the sensing device 100. Furthermore, a current-state temperature distribution data AT is generated according to the sensed temperature T, and a current-state airflow distribution data AF is generated according to the sensed airflow F.

Next, step S602 is executed: the sensing device 100 is connected in series to the data collection and monitoring system, so as to monitor some information of the operating field 2000 and the air conditioning system 2100, Thereby, the boundary condition data B which are associated with the temperature T and the airflow F are obtained.

Next, step S604 is executed: the database 300 stores the current-state temperature distribution data AT and the current-state airflow distribution data AF generated by the sensing device 100, and the current-state temperature distribution data AT and the current-state airflow distribution data AF are established as the current-state data set AD.

On the other hand, step S606 can be executed concurrently with step S600 and step S602: the simulating device 200 performs a simulation with CFD on the temperature T and the airflow F according to the boundary condition data B, so as to generate a simulated temperature distribution data ST and a simulated airflow distribution data SF. After step S606, step S608 is then executed: the simulated temperature distribution data ST and the simulated airflow distribution data SF generated by the simulating device 200 are stored in the database 300, and the simulated temperature distribution data ST and the simulated airflow distribution data SF are established as a simulated data set SD.

After step S604 and step S608, step S610 is then executed: the pre-processing module 420 of the predicting device 400 performs pre-processing (standardization processing and division processing) on the current-state data set AD and the simulated data set SD.

Next, step S612 is executed: the predicting load model 410 of the predicting device 400 performs model operations to predict the future temperature T and airflow F of the operating field 2000, and generates a predicted temperature distribution data PT and a predicted airflow distribution data PF.

Next, step S614 is executed: the control device 500 generates a corresponding control signal C1 according to the predicted temperature distribution data PT and the predicted airflow distribution data PF, and controls the air conditioning system 2100 to adjust the temperature T of the operating field 2000 through the control signal C1. Then, the temperature and airflow predicting method returns to re-execute step S600 and step S606.

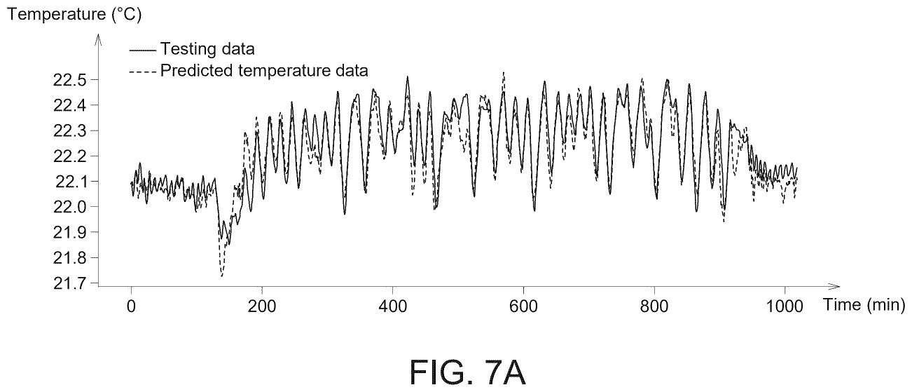

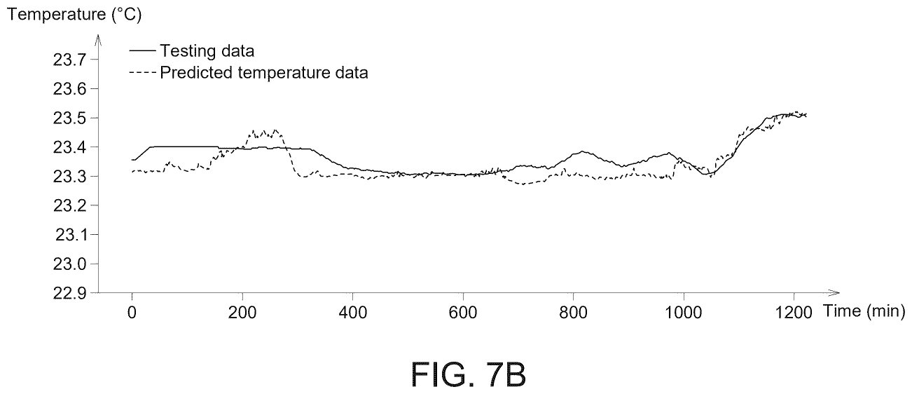

FIGS. 7A and 7B are schematic diagrams of the predicted temperature and test data of the operating field 2000. Firstly, referring to FIG. 7A, the predicted temperature of the operating field 2000 is that, for example, the temperature at the position of the return air channel 2002 in FIG. 3 which is predicted by the temperature and airflow predicting system 1000, so as to obtain the predicted temperature of the return airflow F4 of the return air channel 2002. The variation trend of predicted temperature of the return airflow F4 is substantially consistent with the variation trend of the temperature in the test data. It can be seen that, the temperature and airflow predicting system 1000 has good predicting accuracy.

Next, referring to FIG. 7B, the predicted temperature of the operating field 2000 is that, for example, the predicted temperature of another return air channel of the operating field 2000. The variation trend of predicted temperature is also substantially consistent with the variation trend of the temperature in the test data.

In summary, the temperature and airflow predicting system 1000 of the present disclosure may predict the future temperature T and airflow F of the operating field 2000, by combining the simulation with CFD of the simulating device 200 and the model operations of the predicting device 400. Compared to the traditional predicting method of only performing CFD simulation, the temperature and airflow predicting system 1000 of the present disclosure combines CFD simulation with model operation, which can significantly shorten calculation time for the prediction, and can improve the predicting accuracy. Therefore, computing resources and hardware costs can be greatly saved.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A temperature and airflow predicting system, applied to an operating field, the temperature and airflow predicting system comprising:
a sensing device, for sensing a plurality of temperature readings of the operating field to obtain a current-state temperature distribution data, and sensing a plurality airflow readings of the operating field to obtain a current-state airflow distribution data;
a simulating device, for performing a simulation with computational fluid dynamics (CFD) on temperature and airflow according to a boundary condition data of the operating field, so as to generate a simulated temperature distribution data and a simulated airflow distribution data;
a database, for storing the current-state temperature distribution data and the current-state airflow distribution data to establish a current-state data set, and storing the simulated temperature distribution data and the simulated airflow distribution data to establish a simulated data set; and
a predicting device, for performing a model operation based on the current-state data set, the simulated data set and a predicting load model to predict the temperature and the airflow, so as to generate a predicted temperature distribution data and a predicted airflow distribution data of the operating field.

2. The temperature and airflow predicting system of claim 1, wherein the boundary condition data comprises an air inlet temperature, an air inlet velocity and a return air temperature of the operating field, a temperature and a space information of an internal space of the operating field, and a load of a plurality of operating machines in the operating field.

3. The temperature and airflow predicting system of claim 1, wherein the sensing device is connected in series to a Supervisory Control And Data Acquisition (SCADA) system to obtain the boundary condition data.

4. The temperature and airflow predicting system of claim 1, wherein the operating field has an air conditioning system, and the temperature and airflow predicting system further comprising:
a control device, for controlling the air conditioning system according to the predicted temperature distribution data and the predicted airflow distribution data, so as to adjust the temperature of the operating field.

5. The temperature and airflow predicting system of claim 4, wherein the air conditioning system comprising:
a dry cooling coil, having a water inlet valve and a cooling coil; and
an ice water host, having a water outlet valve and providing an ice water to the cooling coil of the dry cooling coil,
wherein, the control device controls a degree for opening of the water inlet valve of the dry cooling coil and the water outlet valve of the ice water host, so as to adjust a flow rate of the ice water.

6. The temperature and airflow predicting system of claim 5, wherein the degree for opening of the water inlet valve of the dry cooling coil and the water outlet valve of the ice water host is positively correlated with a predicted temperature of a return airflow in the operating field.

7. The temperature and airflow predicting system of claim 1, wherein the predicting load model is a convolutional neural network model, and the predicting load model performs a convolution operation, a maximum pooling operation and a transposed convolution operation.

8. The temperature and airflow predicting system of claim 1, wherein in an actual deployment phase of the predicting load model, the predicting load model performs predicting to generate the predicted temperature distribution data and the predicted airflow distribution data, and in a training phase and a testing phase prior to the actual deployment phase, the predicting load model is trained and tested based on the current-state data set.

9. The temperature and airflow predicting system of claim 8, wherein the predicting device comprising:
a pre-processing module, for performing a standardization processing and a division processing on the current-state data set and the simulated data set before the training phase and the testing phase.

10. The temperature and airflow predicting system of claim 8, wherein the predicting device comprising:
an optimization module, for fine-tuning, calibrating and optimizing the predicting load model according to the simulated data set in a fine-tuning phase after the actual deployment phase.

11. A temperature and airflow predicting method, comprising:
sensing a temperature of an operating field to generate a current-state temperature distribution data and sensing an airflow of the operating field to generate a current-state airflow distribution data, by a sensing device;
performing a simulation with computational fluid dynamics (CFD) on temperature and airflow according to a boundary condition data of the operating field, so as to generate a simulated temperature distribution data and a simulated airflow distribution data, by a simulating device;
storing the current-state temperature distribution data and the current-state airflow distribution data to establish a current-state data set, and storing the simulated temperature distribution data and the simulated airflow distribution data to establish a simulated data set, by a database; and
performing a model operation based on the current-state data set, the simulated data set and a predicting load model by a predicting device to predict the temperature and the airflow, so as to generate a predicted temperature distribution data and a predicted airflow distribution data of the operating field.

12. The temperature and airflow predicting method of claim 11, wherein the boundary condition data comprises an air inlet temperature, an air inlet velocity and a return air temperature of the operating field, a temperature and a space information of an internal space of the operating field, and a load of a plurality of operating machines in the operating field.

13. The temperature and airflow predicting method of claim 11, wherein the sensing device is connected in series to a Supervisory Control And Data Acquisition (SCADA) system to obtain the boundary condition data.

14. The temperature and airflow predicting method of claim 11, wherein the operating field has an air conditioning system, and the temperature and airflow predicting method further comprising:
controlling the air conditioning system according to the predicted temperature distribution data and the predicted airflow distribution by a control device, so as to adjust the temperature of the operating field.

15. The temperature and airflow predicting method of claim 14, wherein the air conditioning system comprises a dry cooling coil having a water inlet valve and a cooling coil, and an ice water host having a water outlet valve and providing an ice water to the cooling coil of the dry cooling coil, and the temperature and airflow predicting method further comprising:
controlling a degree for opening of the water inlet valve of the dry cooling coil and the water outlet valve of the ice water host by the control device, so as to adjust a flow rate of the ice water.

16. The temperature and airflow predicting method of claim 15, wherein the degree for opening of the water inlet valve of the dry cooling coil and the water outlet valve of the ice water host is positively correlated with a predicted temperature of a return airflow in the operating field.

17. The temperature and airflow predicting method of claim 11, wherein the predicting load model is a convolutional neural network model, and the predicting load model performs a convolution operation, a maximum pooling operation and a transpose convolution operation.

18. The temperature and airflow predicting method of claim 11, wherein in an actual deployment phase of the predicting load model, the temperature and airflow predicting method further comprising:
performing predicting to generate the predicted temperature distribution data and the predicted airflow distribution data by the predicting load model; and
in a training phase and a testing phase prior to the actual deployment phase, training and testing the predicting load model based on the current-state data set.

19. The temperature and airflow predicting method of claim 18, further comprising:
before the training phase and the testing phase, performing a standardization processing and a division processing on the current-state data set and the simulated data set by a pre-processing module of the predicting device.

20. The temperature and airflow predicting method of claim 18, further comprising:
in a fine-tuning phase after the actual deployment phase, performing fine-tuning, calibrating and optimizing the predicting load model according to the simulated data set by an optimization module of the predicting device.
